(19) United States
(12) Patent Application Publication
(10) Pub. No.: US 2015/0378143 A1
(43) Pub. Date: Dec. 31, 2015

(54) WHOLE SLIDE IMAGING

(71) Applicant: Louis Auguste, London (GB)

(72) Inventor: Louis Auguste, London (GB)

(21) Appl. No.: 14/314,456

(22) Filed: Jun. 25, 2014

(51) Int. Cl. G02B 21/36; G02B 21/26

(52) U.S. Cl. CPC G02B 21/362; G02B 21/26; G02B 21/367

(57) ABSTRACT

An imaging apparatus includes a microscope comprising an eyepiece and a stage for supporting a sample slide, an electronic mobile imaging and communication device having an image detector, and an adaptor having a coupler portion, a support plane, and a through-hole extending through the support plane and the coupler portion, in which the coupler is positioned on the eyepiece of the microscope, and in which the electronic mobile imaging and communication device is positioned on the support plane.

### TECHNICAL FIELD

The present disclosure relates to whole slide imaging.

### BACKGROUND

In the field of healthcare, developing nations often lack the resources and medical personnel necessary to provide patients with quick diagnoses and prompt medical treatment. For instance, in Haiti there are approximately 5 pathologists for every 10 million persons, whereas in the United States, there are about 5 pathologists for every 90,000 people. Due to the limited number of pathologists in places such as Haiti, analysis and reporting of test results back to a patient or the patient's doctor may take many weeks, if not months. Moreover, the imaging systems used to perform whole slide analysis of test samples typically include large and prohibitively costly cameras mounted to a microscope, as well as a separate table-top PC or other computer coupled to the camera to control and record imaging by the camera. Additionally, the whole slide images produced by those systems are very large, requiring a substantial amount of memory to store and discouraging transfer of data over networks due to bandwidth limitations.

### SUMMARY

Whole slide digital imaging uses computerized technology to scan and convert pathology specimen glass slides into digital images which then are accessible for analysis using viewing software. This sometimes is referred to as virtual microscopy because the digital images may be viewed without the use of a microscope or slides. The digital images of the slides typically are maintained in an information management system that allows for archival and intelligent retrieval. Computerized image analysis tools can be used with digital slides to perform objective quantification measures for special stains and tissue analysis.

The present disclosure relates to a whole slide imaging apparatus for quick and relatively low cost imaging of whole specimen slides. The apparatus includes a microscope for holding a specimen slide, an electronic mobile imaging and communication device for imaging the slide through the microscope, and an adaptor configured to receive and position a camera of the electronic device on an eyepiece of the microscope. The apparatus is further configured to obtain multiple images of the specimen slide and combine those multiple images into a single image.

In general, in a first aspect, the subject matter of the disclosure may be embodied in a an imaging apparatus that includes a microscope comprising an eyepiece and a stage for supporting a sample slide, an electronic mobile imaging and communication device having an image detector, and an adaptor having a coupler portion, a support plane, and a through-hole extending through the support plane and the coupler portion, in which the coupler is positioned on the eyepiece of the microscope, and in which the electronic mobile imaging and communication device is positioned on the support plane.

Implementations of the imaging apparatus can include one or more of the following features and/or features of other aspects. For example, in some implementations, the image detector may be aligned over the through-hole and with an optical axis of the eyepiece.

In some implementations, the coupler portion is adjustable.

In some implementations, the adaptor comprises a raised frame extending around a perimeter of the support plane. The frame may extend entirely around the perimeter of the support plane. The frame may include multiple ridges separated by one or more gaps.

In some implementations, the apparatus further includes a motor coupled to the sample stage. The imaging and communication device may be electronically coupled to the motor and include memory and an electronic processor programmed to perform operations comprising controlling the motor to cause the sample stage to move.

In some implementations, the imaging and communication device includes memory and an electronic processor programmed to perform operations including: acquiring a plurality of panoramic images; and merging the plurality of panoramic images into a single composite image.

In some implementations, the electronic mobile imaging and communication device is a mobile phone.

In general, in another aspect, the subject matter of the disclosure may be embodied in a method of performing whole slide imaging that includes: using an electronic mobile imaging and communication device to obtain multiple panoramic images of a sample through an eyepiece of a microscope; and combining the panoramic images to obtain a single composite image.

Implementations of the method can include one or more of the following features and/or features of other aspects. For example, in some implementations, the method further includes supporting the electronic mobile imaging and communication device on an adaptor coupled to the eyepiece of the microscope. Supporting the electronic mobile imaging and communication device may include: placing the imaging and communication device on a support plane of the adaptor; placing a coupler portion of the adaptor on the eyepiece; and aligning an image detector of the imaging and communication device with a through-hole that extends through the support plane and with an optical axis of the eyepiece.

In some implementations, using the electronic mobile imaging and communication device to obtain the multiple panoramic images includes, for each panoramic image, translating a sample stage of the microscope while acquiring the image. The sample stage may be translated using a motor. Using the electronic mobile imaging and communication device to obtain the multiple panoramic images may further include registering the multiple images. Using the electronic mobile imaging and communication device to obtain the multiple images may further include reducing a resolution of each registered image; and vignetting each low resolution registered image.

In some implementations, the method includes using the electronic mobile imaging and communication device to combine the multiple panoramic images to obtain a single composite image.

In general, in another aspect, the subject matter of the disclosure may be embodied in an adaptor for mounting an imaging device to a microscope, in which the adaptor includes: a coupler portion; a support plane for receiving the imaging device; and a through-hole extending through the support plane and the coupler portion, in which the coupler includes an elongated opening configured to be positioned over a microscope eyepiece. Implementations of the adaptor can include one or more of the following features and/or features of other aspects. For example, the adaptor may include a raised frame extending around a perimeter of the support plane, in which the coupler portion is adjustable. The adaptor may include a spacer configured to be positioned inside of the coupler, in which the spacer has a substantially cylindrical shape and a hollow center.

Certain implementations may have particular advantages. For example, in some implementations, the amount of time that it takes to receive a diagnosis and analysis of the specimen may be substantially reduced. Such reduction in diagnosis time may be especially crucial when determining how to treat a patient with an unknown ailment or disease. Furthermore, using a mobile imaging and communication device may, in some implementations, substantially reduce the costs and time associated with obtaining a diagnosis for a patient. In particular, the adaptor and mobile imaging and communication device may allow rapid acquisition of specimen images without the need for separate large and expensive cameras and computing devices to perform whole slide sampling.

The details of one or more implementations are set forth in the accompanying drawings and the description below. Other aspects, features and advantages will be apparent from the description, drawings, and claims.

### BRIEF DESCRIPTION OF THE DRAWINGS

FIG. 1 is a schematic illustrating a side view of an example apparatus for performing whole slide imaging.

FIGS. 2 and 3 are schematics illustrating a front view and perspective view of the apparatus of FIG. 1, respectively.

FIG. 4 is a schematic illustrating a close-up perspective view of the apparatus of FIG. 1.

FIG. 5 is a schematic that illustrates a frontside view of an example adaptor.

FIG. 6 is a schematic that illustrates a backside view of an example adaptor.

FIGS. 7A-7B are flow charts depicting an example of a process of using an apparatus containing a mobile imaging and communication device to perform whole-slide imaging.

FIG. 8 is an arrangement of panoramic images obtained using the process shown in FIG. 7.

FIG. 9 is a composite image of a sample obtained using the process set forth in FIG. 7.

FIG. 10 is a composite image of a sample obtained using the process set forth in FIG. 7, in which the boundaries of each panorama image forming the composite image are shown.

FIG. 11 is a schematic that illustrates an example of an apparatus for performing whole slide imaging.

FIGS. 12A-12C are schematics that illustrate examples of spacers that may be used with an adaptor.

### DETAILED DESCRIPTION

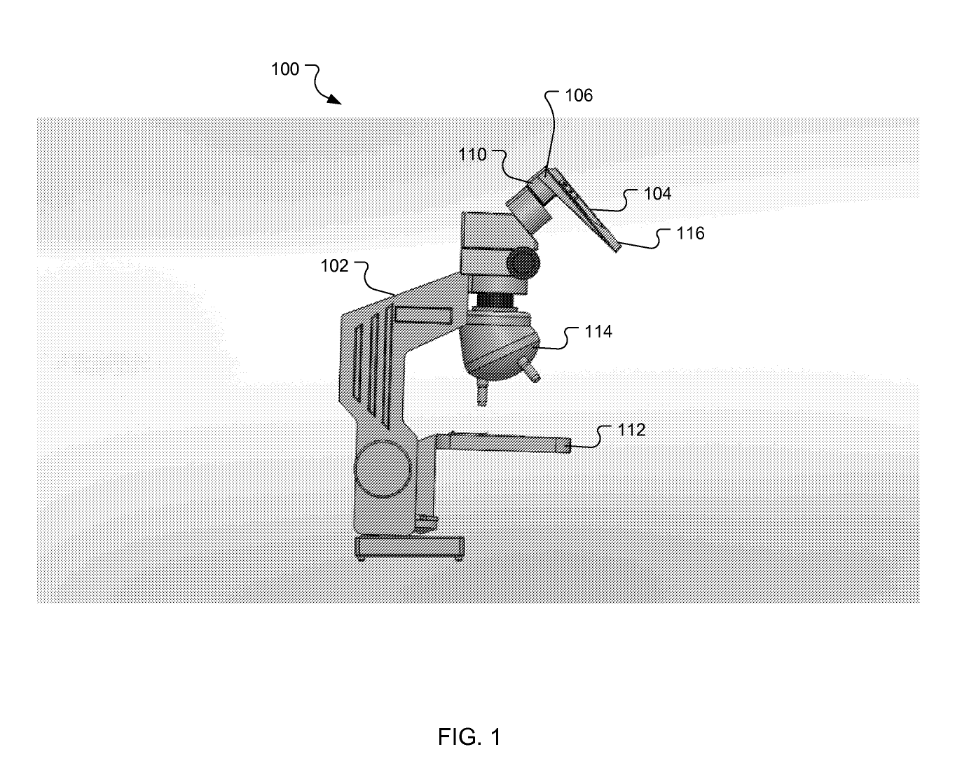

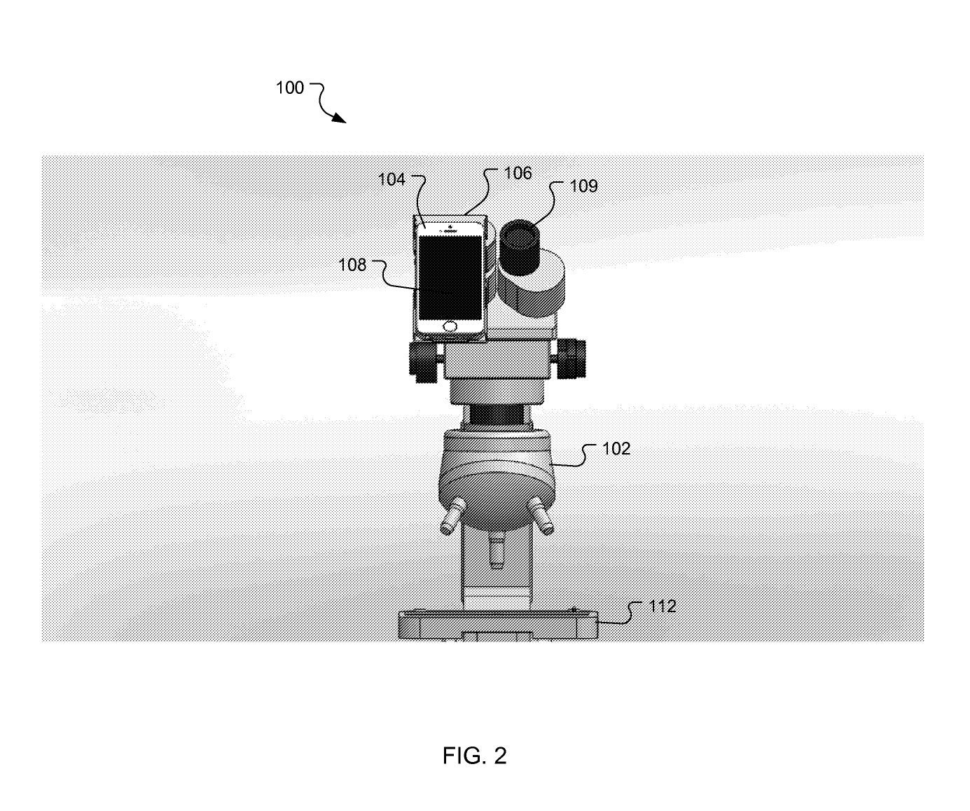

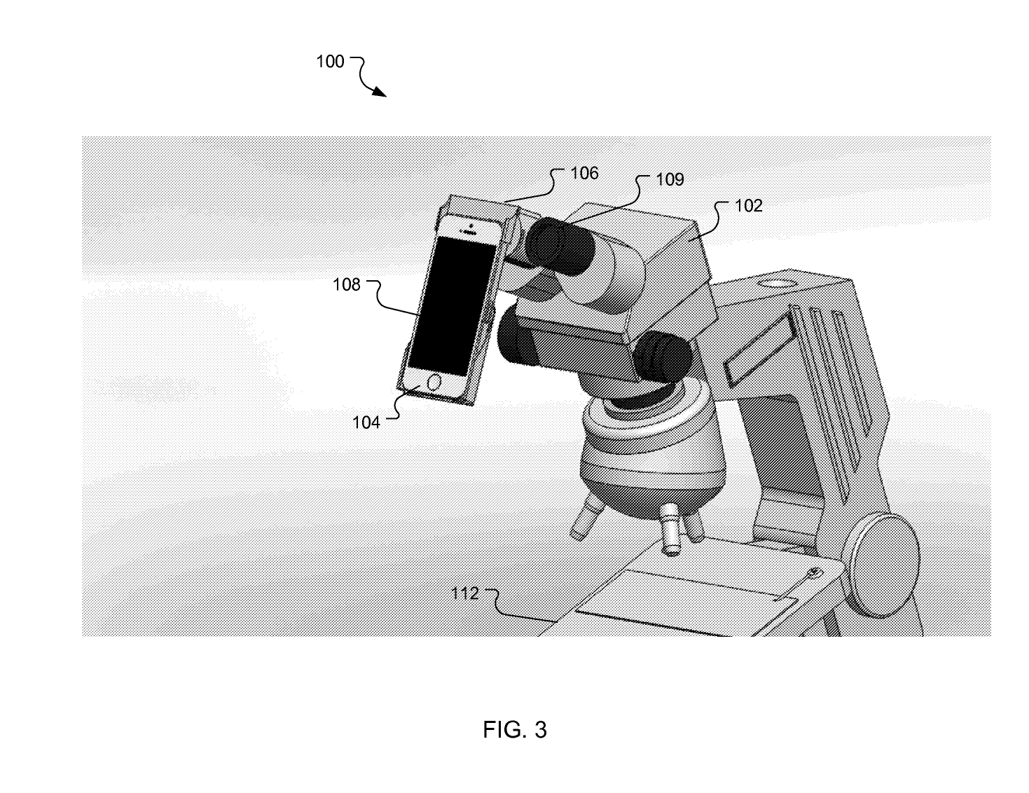

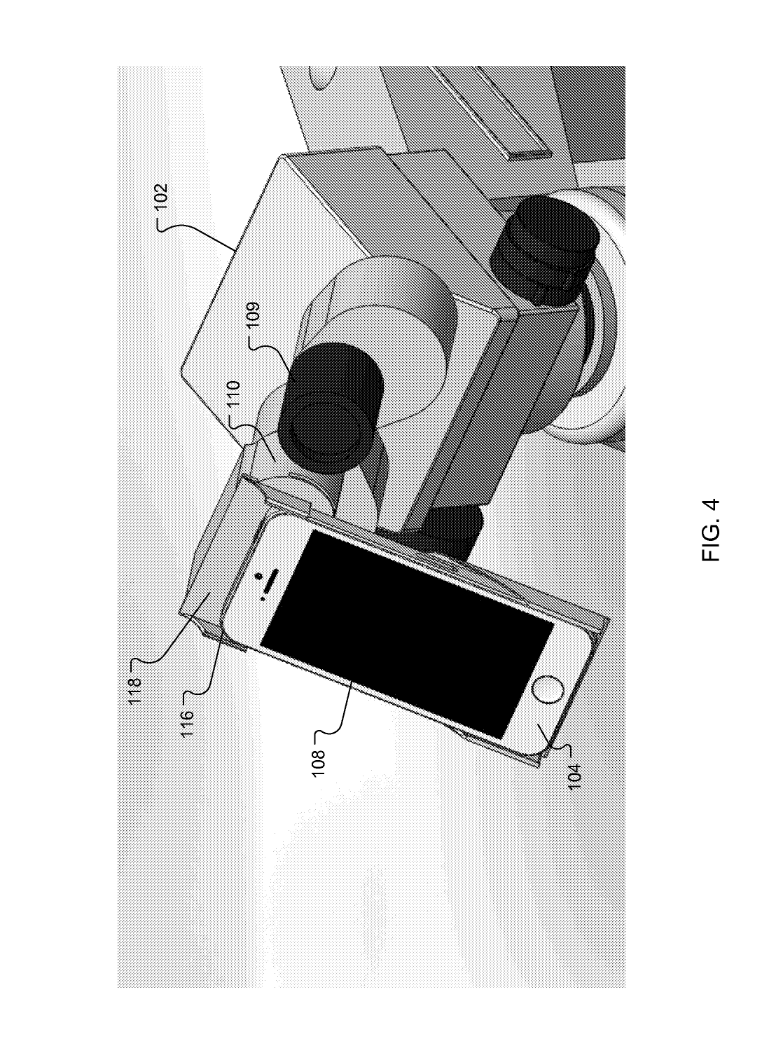

FIG. 1 is a schematic illustrating a side view of an example apparatus 100 for performing whole slide imaging. FIGS. 2 and 3 are schematics illustrating a front view and perspective view of the apparatus 100, respectively. The apparatus 100 includes a microscope 102, an electronic mobile imaging and communication device 104 and an adaptor 106 configured to receive and position the mobile imaging and communication device 104 on an eyepiece of the microscope 102 so that the device 104 can readily obtain images of a specimen slide supported on a microscope stage 112. The microscope 102 may include multiple objectives 114 for different magnifications. FIG. 4 is a schematic illustrating a close-up perspective view of the apparatus 100.

The electronic mobile imaging and communication device 104 includes a portable communication device, such as a handheld smartphone (e.g., an Apple iPhone® or a Samsung Galaxy S®, among others), having both an image detector (e.g., a camera) and a viewing screen 108 for viewing images and videos obtained by the image detector. The mobile imaging and communication device 104 also may include a transceiver and other applicable components for sending and receiving telephone calls and communicating data over a network (e.g., wireless networks such as cellular networks, wired networks, and combinations of both wireless and wired networks such as the Internet). The viewing screen 108 of device 104 may include, for example, a touch screen. The image detector of the device 104 is preferably on a first side (i.e., the “backside”) of the device, whereas the viewing screen is arranged on a second opposite side (i.e., the “frontside) of the device, such that when the device 104 is positioned on the adaptor 106, the image detector faces the eyepiece of the microscope and the viewing screen 108 faces away from the microscope 102 so that a user can view the images obtained by the detector.

As shown in FIGS. 1-4, the adaptor 106 is positioned on one of the two eyepieces 109 of the microscope 102. The adaptor 106 includes a coupling portion 110 that sits over the eyepiece 109. The coupling portion 110 is held securely in place on the eyepiece 109 so that the adaptor 106 resists movement if the user accidentally comes into contact or bumps into the adaptor 106. On a side of the adaptor 106 that faces away from the microscope 102, the adaptor 106 includes a frame 116 (See FIGS. 1 and 4) configured to receive and hold the mobile imaging and communication device 104 in place. The area encompassed by the frame 116 is defined to fit firmly around the perimeter of the mobile imaging and communication device 104 so that the device 104 resists movement if the user accidentally comes into contact or bumps into the adaptor 106.

The coupling portion 110 and the frame 116 of the adaptor 106 are separated by a support plane 118 on which the backside of the mobile imaging and communication device 104 rests. When placed over the eyepiece, the support plane 118 of the adaptor 106 is angled such that it is arranged substantially perpendicular to the optical axis of the eyepiece. Angling the adaptor 106 in this manner allows the user to view an image on the viewing screen at the same angle and in a similar manner as one would view an image directly through the microscope eyepiece. Because the adaptor 106 is positioned on the microscope eyepiece, any adjustment in the angle of the eyepiece will result in the same change in angle of the adaptor support plane 118.

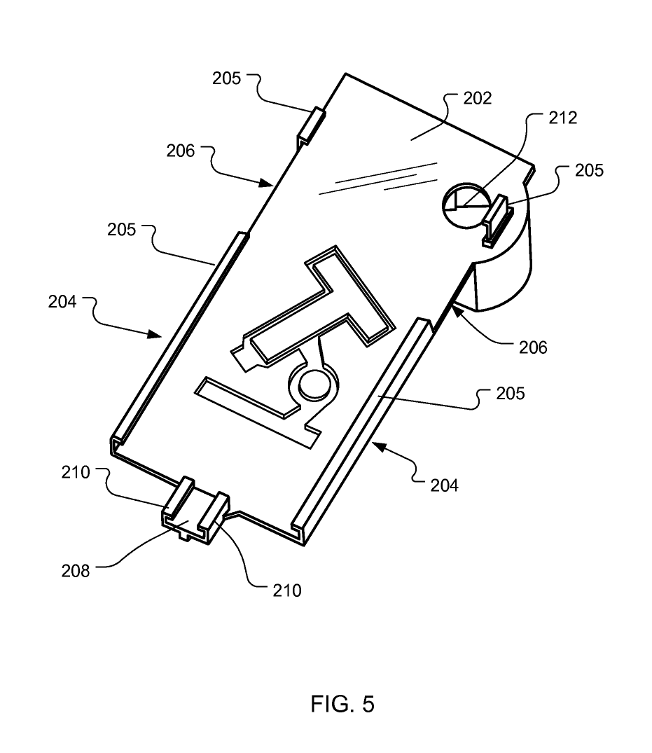

FIG. 5 is a schematic that illustrates a frontside view of the example adaptor 106. As shown in FIG. 5, the adaptor 106 includes the support plane 202 on which the mobile imaging and communication device rests. The support plane 202 is substantially planar such that the planar backside of the mobile imaging and communication device 104 is flush with the plane 202 when placed on the adaptor 106. The adaptor 106 also includes a frame 204. In the example of FIG. 5, the frame 204 includes a series of ridges 205 that protrude from the face of the support plane 202 along the support plane perimeter.

As shown in FIG. 5, the ridges do not extend entirely around the perimeter of the support plane 202. For instance, the frame 204 may include gaps 206 between the ridges of the frame 204. The presence of the gaps 206 may, in some implementations, provide a space through which a user can place his fingers in contact with the mobile imaging and communication device. The space thus provides the user with greater access to the device for removing the device from the adaptor 106 or for placing the device on the support plane 202 of the adaptor 106. As shown in FIG. 5, the ridges of the frame 204 may be located along only two edges of the adaptor 106. Other arrangements of the ridges are also possible. For example, in some cases, the ridges of the frame 204 may extend around the entire perimeter of the support plane 202 without any gaps in the frame 204. Alternatively, the ridges may extend around three edges of the perimeter of the support plane 202 without any gaps in the frame 204 along those edges. In some implementations, the ridges of the frame 204 may extend along three or four edges of the support plane with multiple gaps in the ridges.

In the example shown in FIG. 5, the ridges that form the frame 204 have a height, measured from the support plane 202, that is at least as thick as the mobile imaging and communication device being to be placed on the support plane 202. For instance, the height of the ridges may be at least about 0.30 inches thick, at least 0.34 inches thick, at least about 0.35 inches thick, or at least about 0.37 inches thick. In other implementations, the ridges may have a height that is smaller than the thickness of the mobile imaging and communication device so long as the ridges are high enough that they substantially prevent the device from slipping out of the adaptor 106. The ridges of the frame 204 are wide enough to firmly hold the mobile imaging and communication device in place using friction when positioned on the support plane 202. For example, in some implementations, the width between the ridges is at least about 2.31, at least about 4.9 inches, or at least about 5.4 inches.

In some implementations, the adaptor 106 includes an optional wire harness 208. As shown in the example of FIG. 5, the wire harness 208 is a raised platform extending beyond the bottom edge of the support plane 202 and integrally formed as part of the support plane 202. The raised platform of the wire harness 208 includes separate raised ridges 210 on two opposing edges for securing a wire. When the mobile imaging and communication device is positioned on the support plane 202, the ridges 210 of the wire harness 208 may hold in place a cable or other wire that couples to the device 104. For instance, in the case an iPhone 5 is the mobile imaging and communication device, the wire harness 208 may secure the Apple® Lightning to universal serial bus cable. In some implementations, the wire harness 208 may be considered to be a part of the frame 204 that secures the mobile imaging and communication device in place on the support plane 202. In some implementations, the adaptor includes a lip with an opening through which the cable extends in place of the wire harness.

The adaptor 106 also includes a through-hole 212 that extends through the support plane 202. When the adaptor 106 is positioned on the eyepiece of a microscope, the through-hole 212 is aligned directly over the optical axis of the eyepiece. Furthermore, the center of the through-hole 212 is positioned on the support plane 202 to line up with the image detector of the mobile imaging and communication device. For instance, in the present example, the through-hole 212 is arranged near the upper-right hand corner of the support plane 202 so that when an iPhone 5 mobile phone is placed on the support plane, the camera of the phone is aligned with the center of the through-hole.

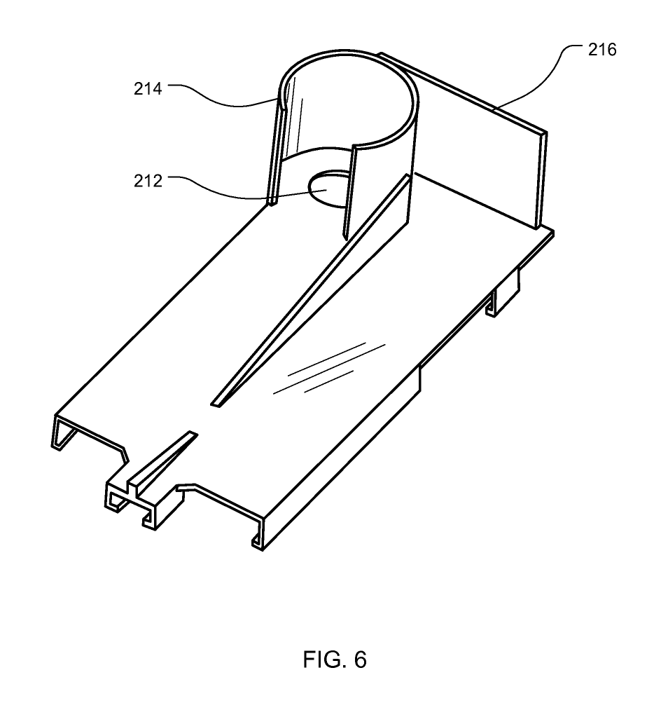

FIG. 6 is a schematic that illustrates a backside view of the example adaptor 106. As shown in the example of FIG. 6, the adaptor 106 includes a coupler 214 for coupling the adaptor 106 to an eyepiece of the microscope. The coupler 214 is a substantially cylindrical projection that extends over the backside of the adaptor 106. In the present example, the coupler 214 is integrally formed with a top wall 216 that is attached to the top edge of the support plane 202. The diameter of the coupler 214 is sized to substantially fit the eyepiece around which the coupler 214 is placed during use of the adaptor 106. For example, typical eyepieces have diameters between about 5 cm and about 8 cm, though other diameters are also possible. In some implementations, a groove is cut between the support plane 202 and the coupler 214 at the position where the support plane 202 and coupler 214 meet, such that substantially most or all of the coupler 214 is not in direct contact with the support plane 202. Instead, the coupler 214 is indirectly attached to the support plane through the top wall 216. By forming this groove in the coupler 214, additionally flexibility is provided to the cylindrical walls of the coupler 214. The added flexibility allows the coupler 214 to expand (e.g., in the direction of arrows shown in FIG. 6) to fit an oversized eyepiece. The through-hole 212 is centered within the coupler 214 so that when the adaptor 106 is placed over an eyepiece of a microscope, the through-hole is aligned with the optical axis of the eyepiece.

The frame 204, wire harness 208, coupler 214 and support plane 202 may be formed of the same material, such as plastic or metal. For example, in some implementations, the frame 204, wire harness 208, coupler 214 and support plane 202 are contiguously formed of a thermosetting plastic, a thermoplastic, polyethylene terephthalate, or other plastic in a single mold.

Referring again to FIG. 1, the specimen slide is held on the microscope stage 112 beneath the microscope objective lens 114. The specimen slide may hold a sample to be diagnosed, such as tissue samples or other samples obtained from a patient. To observe the image of a specimen slide on the viewing screen 108, panoramic image recording software application stored on the device 104 is activated when the device 104 is placed in the adaptor 106 and the adaptor 106 is positioned on the microscope 102. After the panoramic image recording software is activated, a user may translate the stage to obtain one or more panoramic images of the specimen slide. In the case of multiple panoramas, the image recording software application merges the multiple panoramas into a single image.

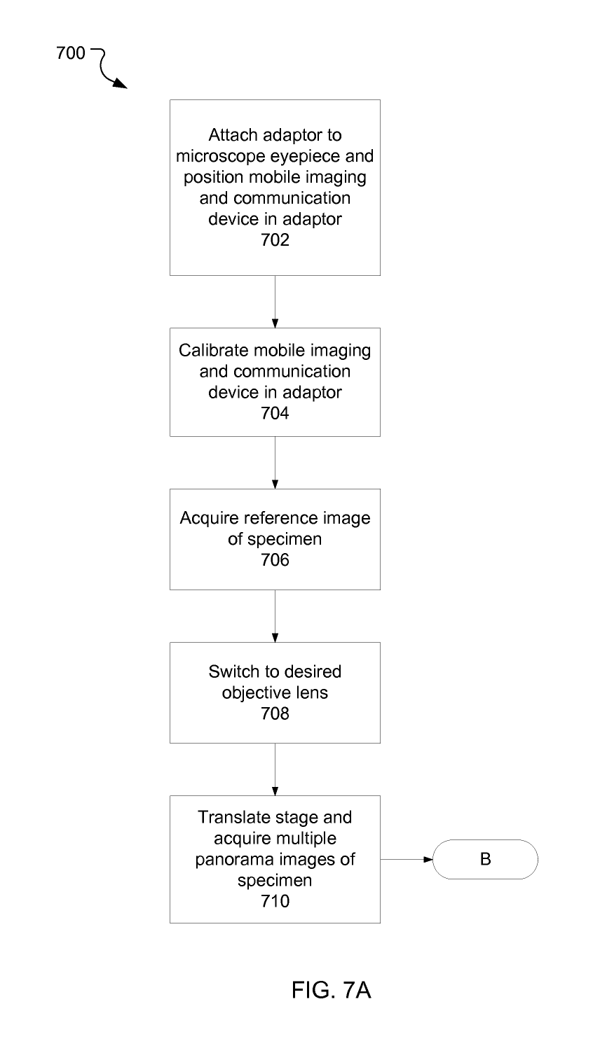

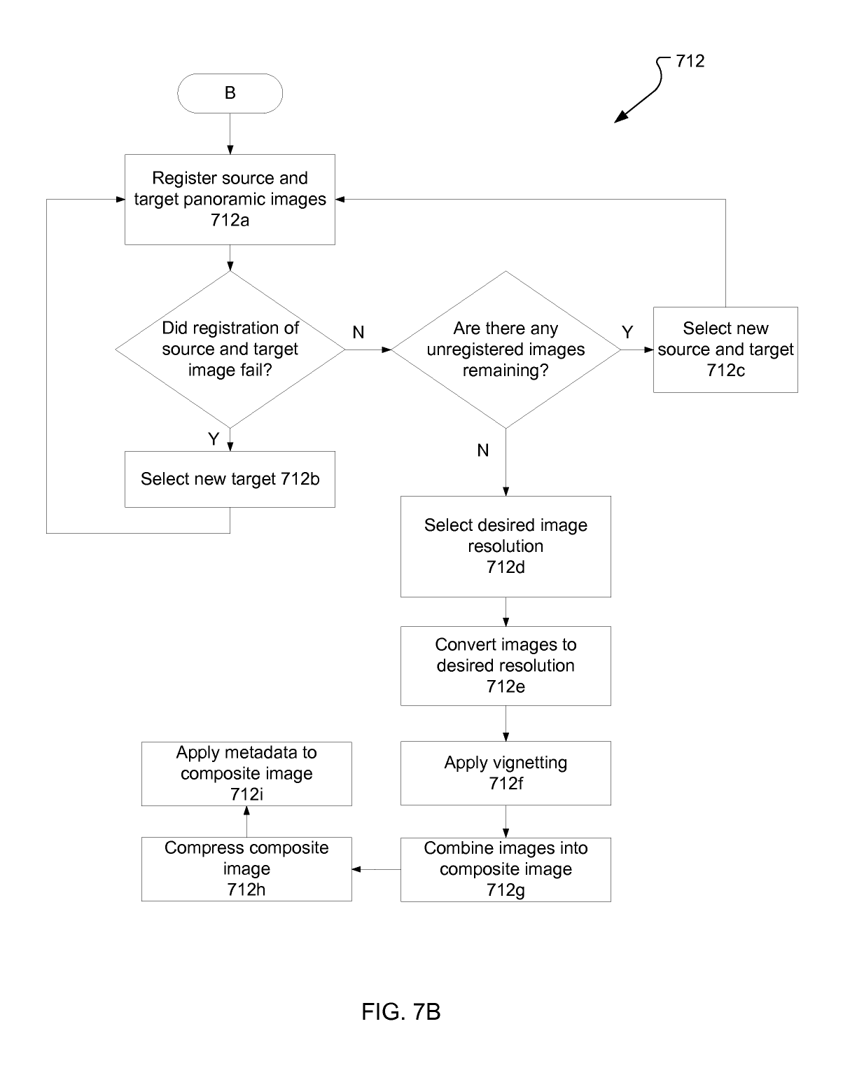

Further detail on the process of obtaining the final image is set forth below and in FIGS. 7A-7B, which are flow charts depicting an example of a process 700 of using an apparatus containing a mobile imaging and communication device (e.g., apparatus 100) to perform whole-slide imaging. First, the adaptor (e.g., adaptor 106) is attached to an appropriate eyepiece of a microscope and the mobile imaging and communication device is positioned in the adaptor (702). This may include making sure that the image detector of the mobile imaging and communication device is aligned correctly with the through-hole of the adaptor and that the through-hole of the adaptor is aligned with the eyepiece. When the panoramic image recording software is activated, it may display a horizontal line (a “viewfinder line”) extending across the screen to aid the user in determining whether the image detector remains level during translation of the device and recording of a panorama image. Using the horizontal viewfinder line, a user then may subsequently calibrate (704) the orientation of the mobile imaging and communication device in the adaptor. Specifically, the user may translate the stage and/or slide so that the horizontal viewfinder line is parallel with an edge of the sample slide. If the viewfinder line visible in the screen of the device is not parallel with the sample slide edge, the user may adjust the adaptor or the device held in the adaptor so that the edge and line are substantially parallel. In some implementations, the image and communication device also includes a gyroscope and corresponding software that allows the position and orientation of the device to be recorded. Once the orientation of the device is calibrated so that it is aligned with the edge of the sample slide, the user may record the calibrated position utilizing the gyroscope and corresponding software. In this way, if the adaptor and/or mobile imaging and communication device should become inadvertently shifted later during the acquisition of panoramas, the user can reference the stored calibration position and orientation to determine how to return the device to its desired position and orientation.

After calibration, the objective is optionally switched to a magnification low enough such that a larger portion of the sample on the slide is visible and centered within the display screen of the image and communication device. A reference image of the sample then is acquired (706). The microscope objective then is switched so that the desired magnification is obtained (708). This may include adjusting the Z-axis of the microscope stage (i.e., adjusting the stage along a direction normal to the surface of the stage on which the sample slide is placed) so that the image is focused.

After the desired magnification is set, the user may start to acquire (710) panoramas of the sample. Acquisition may be performed by translating the sample stage so that it follows an S-like or zig-zag pattern. For instance, in some implementations, the user may move the sample stage to a starting position that corresponds to a corner of the sample to be imaged. It should be noted that the sample viewable in the display is only a portion/subset of the entire sample. Then, starting from the selected corner (e.g., the bottom left hand corner as viewed in the display), the panorama image acquisition program is activated and the stage is translated along the X-direction (e.g., from left to right) with no motion along the Y-direction until an entire panorama image is acquired. Once the panorama image is acquired, the user ceases translating the stage and the image acquisition program stores the acquired image in memory. If the length of the sample to be imaged along the X-direction is longer than the length that can be captured in a single panorama image, the user may again activate the image acquisition and then continue translating the stage in the X-direction. This process may be repeated multiple times until the entire desired sample along the X-direction has been imaged. Accordingly, there may be multiple panorama images that are stored by the mobile imaging and communication device for the total length of translation. To improve the accuracy of the image stitching program that will later combine the acquired panorama images, each panorama image should have some overlap with an adjacent image. That is, for two adjacent panorama images obtained while translating the stage along the X-direction, a portion of the sample contained within each image should be the same. For example, there should be at least 1% overlap, at least 5% overlap, at least 10% overlap, at least 15% overlap, at least 20% overlap, or at least 25% overlap between images. The preferred amount of overlap may depend on the particular implementation.

After the scan along the X-direction is completed (e.g., after there is no more sample along the X-direction to image or after the user determines that the scan along the X-direction does not need to proceed further), the sample stage is translated along the Y-direction (e.g., up or down) to a new row for a new series of image acquisitions. The next series of image acquisitions may begin from this new starting position. In some implementations, the user may also translate the sample stage along a direction opposite to that followed when acquiring the first row of images (e.g., along a negative X-direction such as right to left) to the new starting position.

As before, the user may activate the image acquisition and begin to translate the microscope stage along the new row. Depending on the location of the starting position, the translation during image acquisition may proceed in a direction opposite to that followed when acquiring the first row of images (e.g., along a negative X-direction such as right to left, instead of a positive Y-direction) or in the same direction as followed when acquiring the first row of images (e.g., along the positive X-direction such as left to right). In either case, there should be some overlap with respect to the sample being imaged in the new row and the previous row of images. For example, there should be at least 1% overlap, at least 5% overlap, at least 10% overlap, at least 15% overlap, at least 20% overlap, or at least 25% overlap between an image acquired in the new row and a corresponding image acquired in the previous row of images. Similarly, each image in the new row should overlap with one or more directly adjacent images in the same row. For example, there should be at least 1% overlap, at least 5% overlap, at least 10% overlap, at least 15% overlap, at least 20% overlap, or at least 25% overlap between adjacent images in the new row.

Once the first panorama image in the new row is acquired, the user ceases translating the stage and the image acquisition program stores the acquired image in memory. If the length of the sample to be imaged along the new row is longer than the length that can be captured in a single panorama image, the user may again activate the image acquisition and then continue translating the stage along the new row. This process may be repeated multiple times until the entire desired sample along the new row has been imaged. Accordingly, there may be multiple panorama images that are stored by the mobile imaging and communication device for the total length of translation. Upon reaching the end of the new row (e.g., after there is no more sample left along the X-direction to image or after the user determines that the scan along the X-direction does not need to proceed further), the sample stage is translated along the Y-direction (e.g., up or down) to a second new row for a new series of image acquisitions, and the process described above is repeated.

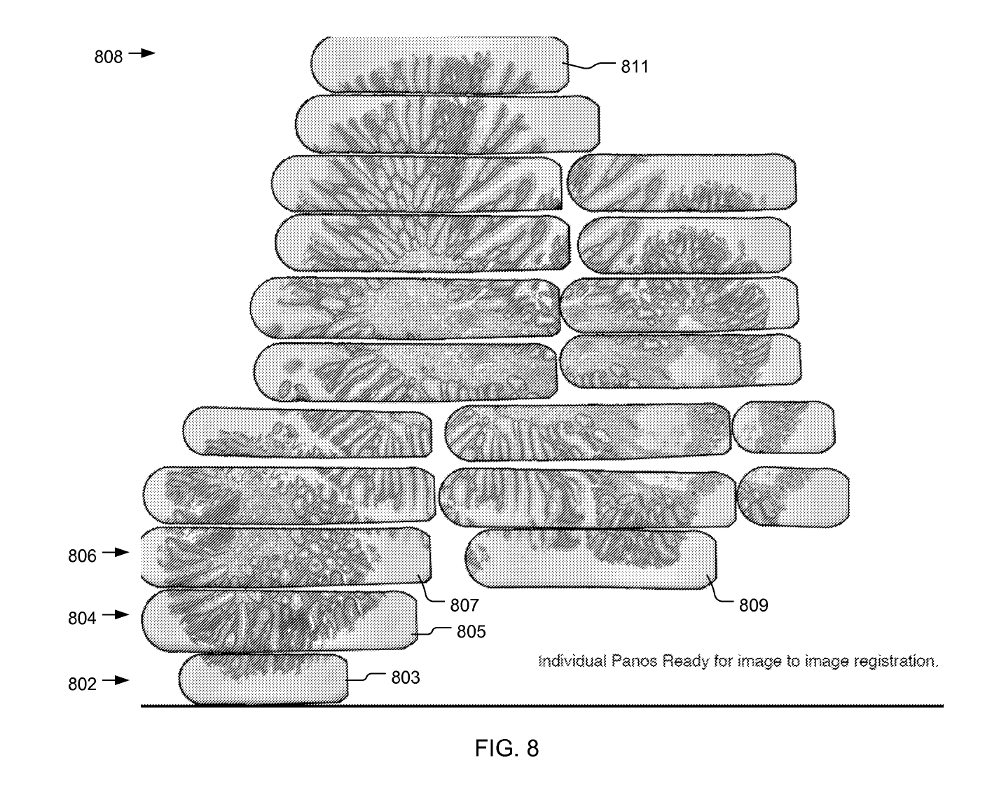

Eventually, the user will have obtained one or more panorama images for multiple rows across the sample. For example, FIG. 8 is an arrangement of panoramic images obtained using the foregoing process. In particular, the images in FIG. 8 were obtained by starting a scan along a first row 802 to obtain a first image 803 of the sample. Then, the stage was translated to a second row 804, where image 805 was obtained. Subsequently, the stage was translated again to a third row 806, where images 807 and 809 were obtained. This process of translation and scanning across the sample was continued until image 811 in row 808 was obtained.

Referring again to FIG. 7, once the multiple panorama images have been acquired, the stored images are combined (712) into a single image of the sample. Combining the multiple panorama images may include applying an image stitching algorithm to the acquired panoramas using image-to-image registration or global image registration. Image registration includes obtaining a single coordinate system for the different panoramic images. In some implementations, the image stitching algorithm may be a commercially available software program such as the Adobe® panoramic image stitching program. Other image stitching algorithms also may be used. The image stitching program may be stored in memory and executed by a processor on the mobile imaging and communication device.

During image-to-image registration, one image is identified as a source or reference image and another image is referred to as a target or sensed image. Various different techniques may be used to perform image registration. For instance, image registration may include intensity-based or feature-based registration. In the case of intensity-based registration, intensity patterns in the source image are compared to intensity patterns in the target image using correlation metrics. The source and/or target images are spatially adjusted (e.g., rotated or translated) to maximize the level of correlation and alignment between the images. Feature-based methods of image registration determine a correspondence between source and target image features such as points, lines, and contours. Again, the source and/or target are adjusted to maximize the correspondence and alignment between the images. Other image registration algorithms also may be used. For instance, the image registration may differ based on the type of transformation (e.g., linear or non-rigid transformation) model used to adjust the source and/or target image. In some implementations, the image registration algorithm used may perform correlation and/or transformation in the frequency domain as opposed to the spatial domain. Other image registration algorithms are also possible.

In some implementations, the image registration proceeds numerically (712a), i.e., the image registration is applied to the images in the order in which they were received/acquired. For instance, the image-stitching program may try to register the source (e.g., the first acquired image) with the target (e.g., the second subsequently acquired image). If the image registration between the source and target fails (e.g., because the panoramas do not correspond to images of adjacent positions on the sample), the algorithm then attempts to register the source image with the next acquired image as the target (712b) and so on until registration between the source and another image is achieved. If, on the other hand, the source and target can be registered, the image-stitching program then uses the second acquired image as the source and attempts to register the source with a new target (e.g., the third acquired image) (712c). Steps 712b and 712c are repeated until all the acquired images are registered.

In some implementations, registration between two images fails due to poor overlap between the source and target images. The image stitching program then may allow the user to re-acquire the source and/or target image to increase the amount of overlap.

In some implementations, the image-stitching program uses a global image registration instead of a sequential image-to-image registration. Global image registration entails attempting to register all of the images with one another at the same time instead of applying the registration in sequence to image pairs.

After the acquired images are registered, a desired resolution of the output file can be selected (712d). In some implementations, the resolution is selected automatically by the image-stitching program. For example, the desired resolution may be a preset value within the image-stitching program. Alternatively, in some implementations, the image stitching program allows the user to select the desired resolution. For instance, the image stitching program may display to the user a drop-down menu that lists different image resolutions from which the user may select. Alternatively, the image stitching program may provide the user with a text entry field into which the user may enter a desired image resolution. The resolution that is entered should be lower than the resolution of the acquired images.

After the desired resolution has been selected by the user or by the image stitching program, the image stitching program converts (712e) each registered image into a lower resolution version of itself, based on the resolution selected in (712d). Subsequently, the image stitching program applies an optional vignette step (712f) to each of the low resolution registered images.

After the registration, resolution conversion and vignetting steps, the image stitching program combines the images into a single composite image in a mosaicing step (712g). Subsequently, the composite image optionally may be compressed (712h) and/or wrapped with metadata (712i). An example of wrapping the composite image with meta data includes saving the image file according to the Digital Imaging and Communications in Medicine (DICOM) standard (also know as NEMA standard PS3 or ISO standard 12052:2006). DICOM is a known standard for handling, storing, printing, and transmitting information in medical imaging and includes a file format definition and a network communications protocol.

The images acquired by the mobile imaging and communication device, the compressed images, and the composite images may be stored in memory of the mobile imaging and communication device as one or more digital file formats. For instance, the images may be stored as JPEG, TIFF, RAW, GIF, BMP, PNG, or HDR file formats. Other image file formats are possible as well.

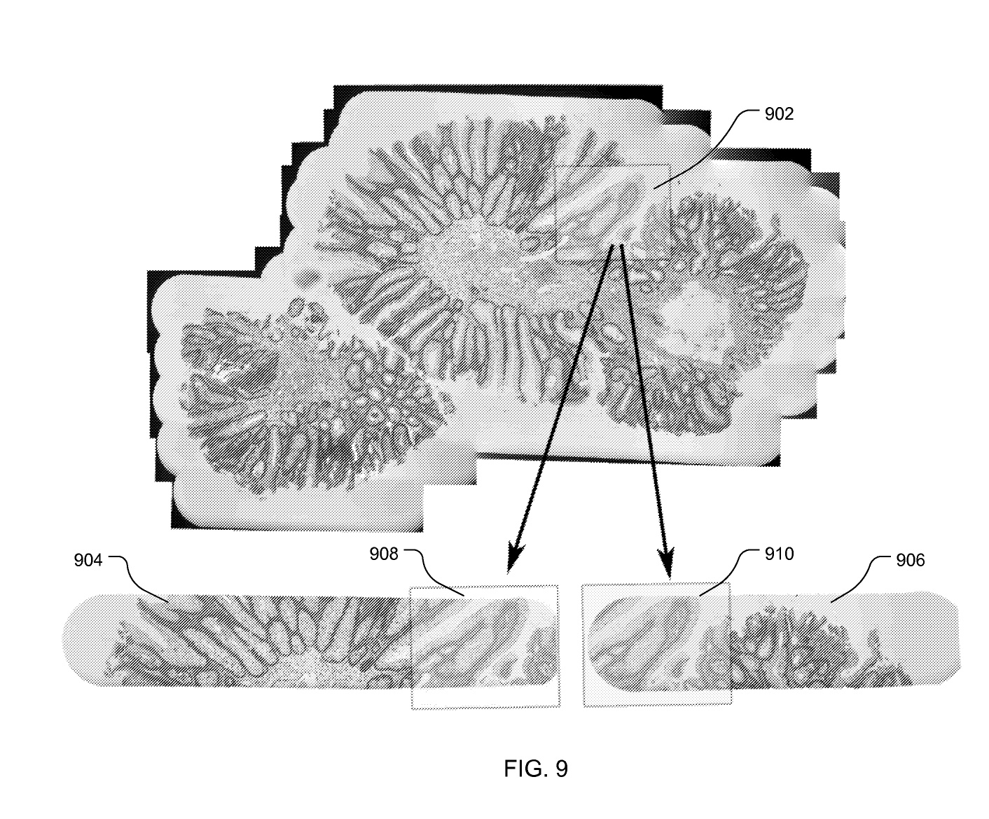

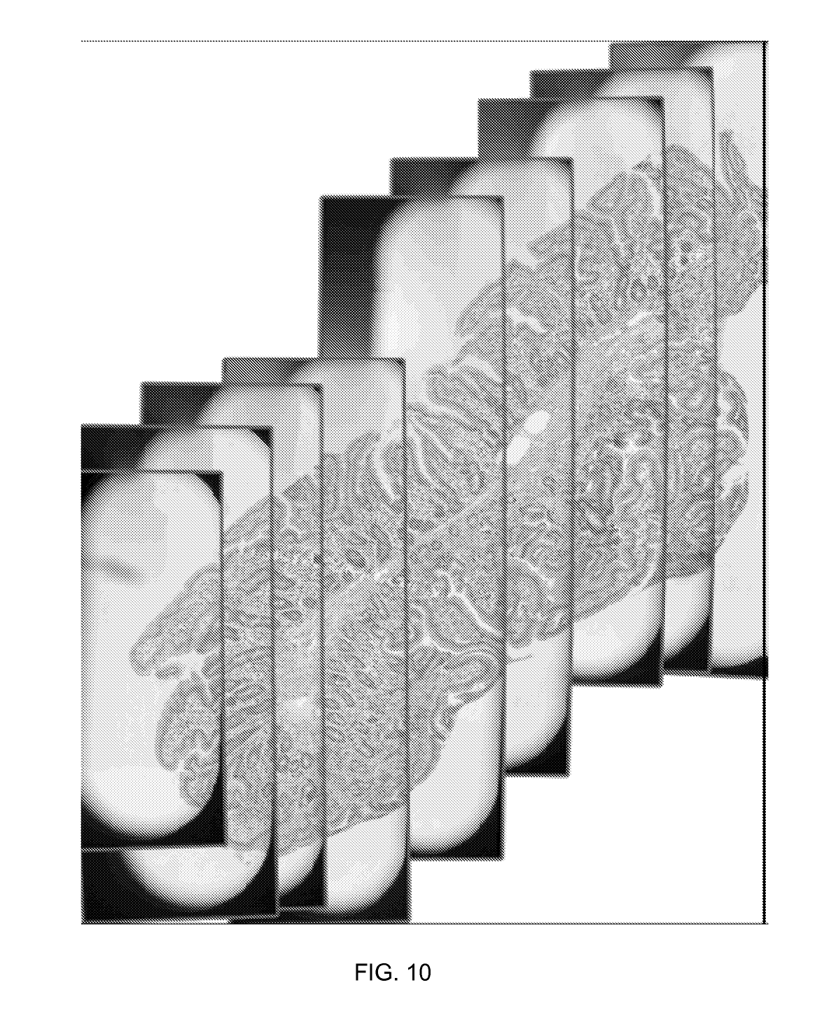

FIG. 9 is a composite image of an entire sample obtained using the process set forth in FIG. 7 and an apparatus such as apparatus 100. The mobile imaging and communication device used in the apparatus was an iPhone 5 and the image-stitching software was Adobe Photoshop. Other image-stitching software may also be used. The region 902 of the composite image was obtained by stitching together at least the two panorama images 904, 906. The regions 908, 910 of overlap between the two panorama images are also shown. FIG. 10 is a composite photograph of another sample, in which the composite picture shows the boundaries of each panorama image, thus further illustrating the overlap between images.

Once a composite image is obtained and wrapped with meta data, a user may store the composite image on the mobile imaging and communication device (e.g., device 104) and/or send the image from the imaging and communication device over a network to another user. For instance, the user operating the apparatus 100 including the device 104 may be a technician in an isolated part of a country where there are few or no pathologists available for analyzing the specimen. The technician may send the composite image of the specimen from the device 104 to a pathologist in another part of the country or in a different country to obtain his analysis of the imaged specimen. As a result, the amount of time that it takes to receive a diagnosis and analysis of the specimen may be substantially reduced. Such a reduction in diagnosis time may be especially crucial when determining how to treat a patient with an unknown ailment or disease. Furthermore, using a mobile/handheld imaging and communication device (e.g., device 104) may, in some implementations, also reduce the costs and time associated with obtaining the diagnosis. In particular, the mobile imaging and communication device may be positioned quickly on the adaptor and may be used for both image acquisition and analysis. Thus, the need for separate large and expensive cameras and computing devices that are traditionally used for performing whole slide sampling is significantly reduced.

Embodiments of the subject matter and the functional operations described in this specification, such as one or more of the operations described with respect to the process 700, can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory program carrier for execution by, or to control the operation of, data processing apparatus such as the imaging and communication device 104. The computer storage medium can be a machine-readable storage device, a machine-readable storage substrate, a random or serial access memory device, or a combination of one or more of them.

The term “data processing apparatus” refers to data processing hardware and encompasses all kinds of apparatus, devices, and machines for processing data, including by way of example a programmable processor, a computer, or multiple processors or computers. The apparatus can also be or further include special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program (which may also be referred to or described as a program, software, a software application, a software program, a module, a software module, a script, or code) such as the image stitching program or the motion controller program can be written in any form of programming language, including compiled or interpreted languages, or declarative or procedural languages, and it can be deployed in any form, including as a stand alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on the data processing apparatus.

Multiple operations described in this specification (e.g., operation 712 in process 700) may be performed by the data processing apparatus executing one or more computer programs to perform functions by operating on input data and generating output. The operations can also be performed by, and apparatus can also be implemented as, special purpose logic circuitry, e.g., an FPGA (field programmable gate array) or an ASIC (application specific integrated circuit).

Data processing apparatus suitable for the execution of a computer program include, by way of example, can be based on general or special purpose microprocessors or both, or any other kind of central processing unit. Generally, a central processing unit will receive instructions and data from a read only memory or a random access memory or both. The essential elements of a data processing apparatus are a central processing unit for performing or executing instructions and one or more memory devices for storing instructions and data. Generally, a data processing apparatus will also include, or be operatively coupled to receive data from or transfer data to, or both, one or more mass storage devices for storing data, e.g., magnetic, magneto optical disks, or optical disks. However, a data processing apparatus need not have such devices. Moreover, a data processing apparatus can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a data processing apparatus having a display device, e.g., a touch-sensitive display screen, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

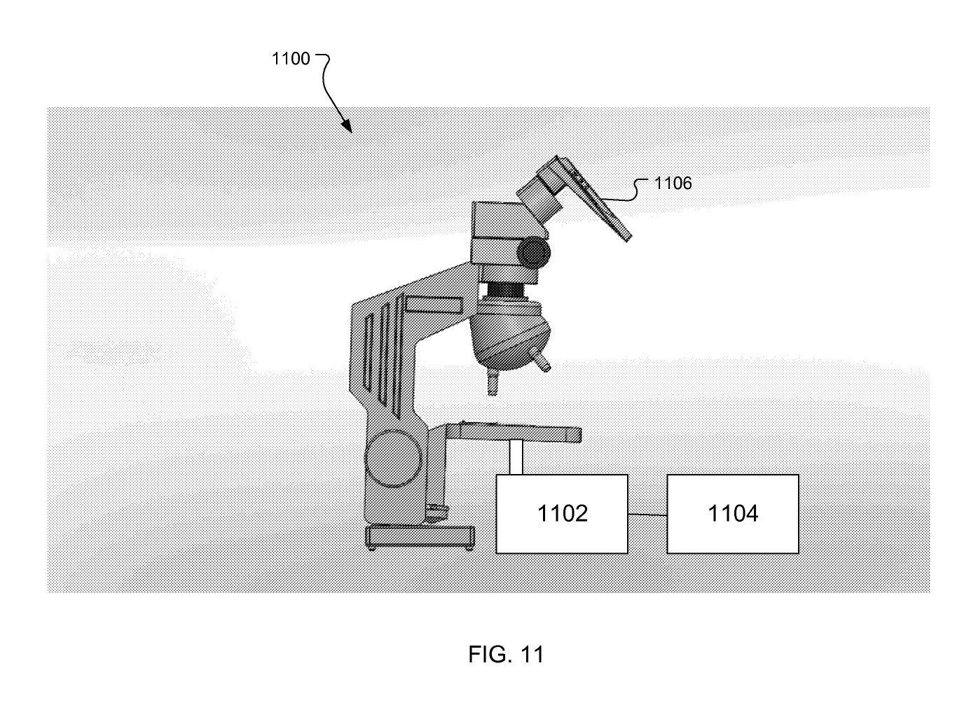

A number of implementations have been described. Nevertheless, it will be understood that various modifications may be made without departing from the spirit and scope of the invention. For example, in some implementations, the operations (704) to (710) of process 700 may be performed manually by a user. Alternatively, in some implementations, one or more of operations (704) to (710) may be performed automatically without human intervention. For example, in some cases, the apparatus 100 may include a motor (e.g., a servomotor or a stepper motor) coupled to the microscope translation stage, in which the motor is also coupled to the imaging and communication device for controlling the motor. The imaging and communication device may store in its memory a motion controller software program that, upon execution by the device, is configured to perform operations that include automatically activating the motor so that the stage is translated according to a predefined pathway. The motion controller software program also may be configured to cause the image detector of the device to automatically capture and store the panorama images of the sample slide at the same time the microscope stage is being translated. In such implementations, the translation of the microscope stage and/or the acquisition and storing of the images may be performed automatically, with user intervention being required primarily to start the motion controller software program. FIG. 11 is a schematic that illustrates an example of an apparatus 1100 for performing whole slide imaging, in which the apparatus 1100 is similar in construction to the apparatus of FIG. 1, except that the apparatus 1100 also is coupled to a motor 1102 for actuating the sample stage of the apparatus 1100. An electronic processor 1104 is coupled to the motor 1102 for sending control signals to activate the motor 1102. Alternatively, the motor 102 may be coupled to the electronic mobile imaging and communication device 1106 and may receive the actuation control signals from the device 1106. The motor 1102 may be coupled to the device 1106 through a cable or wirelessly.

The process 700 is described above with respect to obtaining multiple panorama images and stitching those images together into a single composite image. However, in some implementations, the subset of images used to form the composite image may be obtained from a video recording instead of multiple separate panoramas. For example, in some cases, the mobile imaging and communication device may have 4K video resolution. 4K resolution is a term for display devices or content having a horizontal resolution on the order of 4,000 pixels. Thus, each frame of a video recorded by such a mobile imaging and communication device would have on the order of 4K resolution. With such high resolution, the image acquisition process would entail recording video in place of obtaining separate panoramic images. Then, individual still frames from the video may be composited into a single image using the image-stitching software.

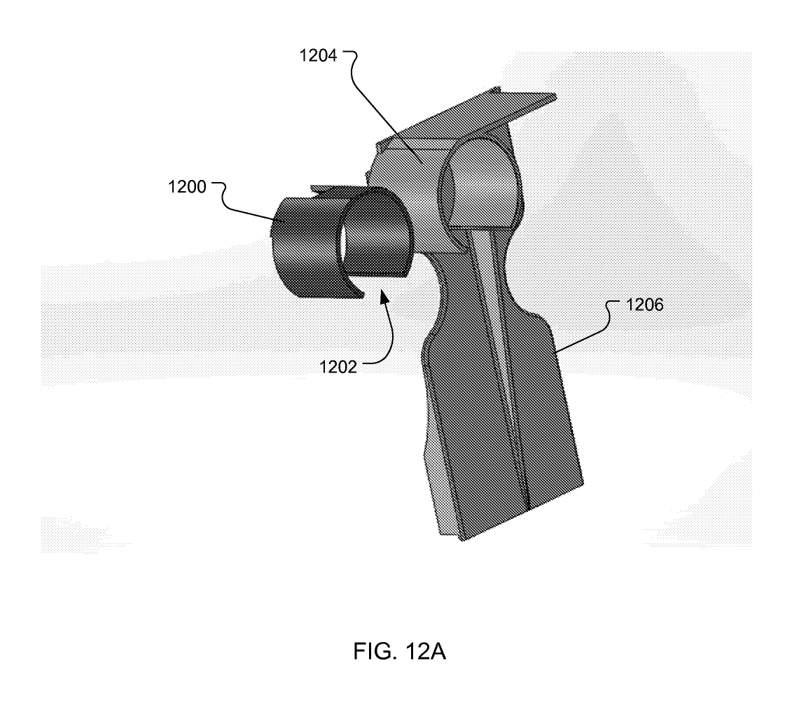

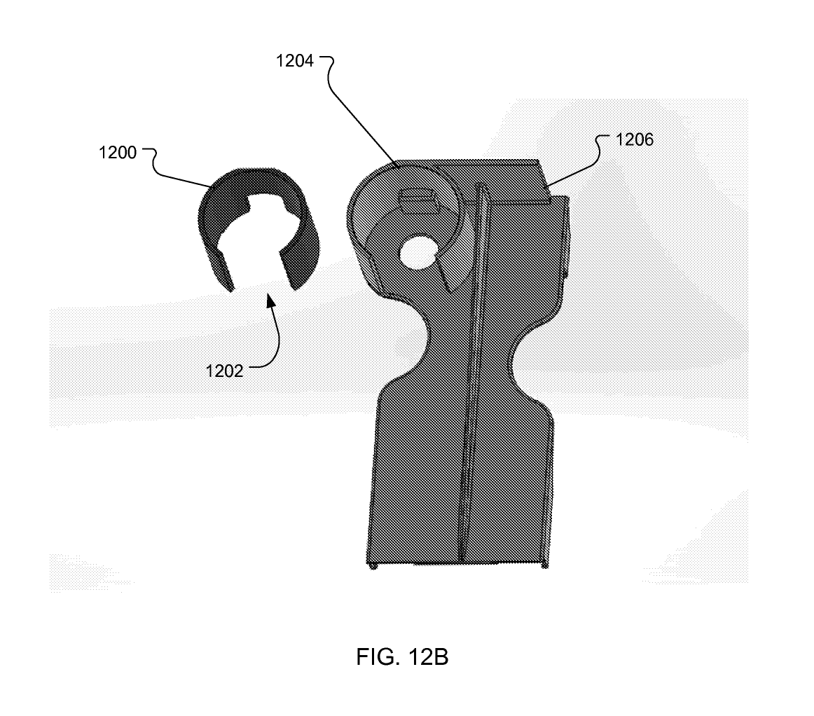

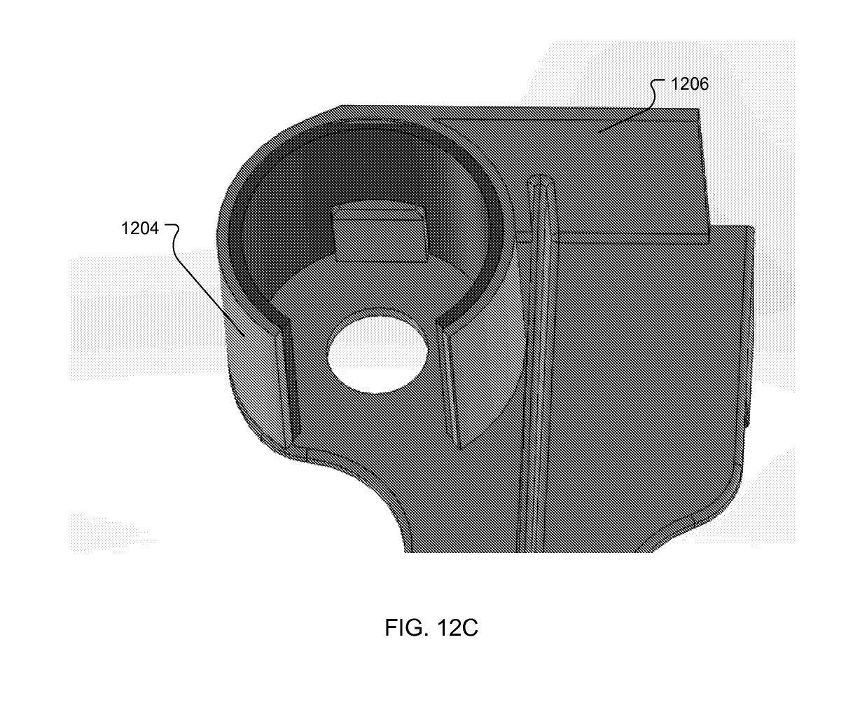

In some implementations, the adaptor may utilize one or more different sized-spacers to secure the coupler over the eyepiece of the microscope. Depending on the size of the eyepiece, a different size-spacer can be chosen. FIGS. 12A-12C are schematics that illustrate examples of spacers that may be used with the adaptor. As shown in FIGS. 12A-12B, a spacer 1200 may be substantially shaped like a hollow cylinder. The spacer 1200 may include an opening 1202 to provide the spacer with flexibility. The spacer 1200 fits inside coupler 1204 of the adaptor 1206 (see FIG. 12C). The walls of the different spacers may have different thicknesses, such that the spacers have different diameters for accommodating the different eyepiece sizes.

While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results.

Other implementations are within the scope of the following claims.

What is claimed is:

1. An imaging apparatus comprising:
a microscope comprising an eyepiece and a stage for supporting a sample slide;
an electronic mobile imaging and communication device comprising an image detector; and
an adaptor comprising a coupler portion, a support plane, and a through-hole extending through the support plane and the coupler portion, wherein the coupler is positioned on the eyepiece of the microscope, and wherein the electronic mobile imaging and communication device is positioned on the support plane.

2. The imaging apparatus of claim 1, wherein the image detector is aligned over the through-hole and with an optical axis of the eyepiece.

3. The imaging apparatus of claim 1, wherein the coupler portion is adjustable.

4. The imaging apparatus of claim 1, wherein the adaptor comprises a raised frame extending around a perimeter of the support plane.

5. The imaging apparatus of claim 4, wherein the frame extends entirely around the perimeter of the support plane.

6. The imaging apparatus of claim 4, wherein the frame comprises a plurality of ridges separated by one or more gaps.

7. The imaging apparatus of claim 1, further comprising a motor coupled to the sample stage.

8. The image apparatus of claim 7, wherein the imaging and communication device is electronically coupled to the motor and comprises memory and an electronic processor programmed to perform operations comprising controlling the motor to cause the sample stage to move.

9. The image apparatus of claim 1, wherein the imaging and communication device comprises memory and an electronic processor programmed to perform operations comprising:
acquiring a plurality of panoramic images; and
merging the plurality of panoramic images into a single composite image.

10. A method of performing whole slide imaging comprising:
using an electronic mobile imaging and communication device to obtain a plurality of panoramic images of a sample through an eyepiece of a microscope; and
combining the plurality of panoramic images to obtain a single composite image.

11. The method of claim 10, further comprising supporting the electronic mobile imaging and communication device on an adaptor coupled to the eyepiece of the microscope.

12. The method of claim 11, wherein supporting the electronic mobile imaging and communication device comprises:
placing the imaging and communication device on a support plane of the adaptor;
placing a coupler portion of the adaptor on the eyepiece; and
aligning an image detector of the imaging and communication device with a through-hole that extends through the support plane and with an optical axis of the eyepiece.

13. The method of claim 10, wherein using the electronic mobile imaging and communication device to obtain the plurality of panoramic images comprises, for each panoramic image translating a sample stage of the microscope while acquiring the image.

14. The method of claim 13, wherein the sample stage is translated using a motor.

15. The method of claim 13, wherein using the electronic mobile imaging and communication device to obtain the plurality of panoramic images further comprises registering the plurality of images.

16. The method of claim 15, wherein using the electronic mobile imaging and communication device to obtain the plurality of panoramic images further comprises:
reducing a resolution of each registered image; and
vignetting each low resolution registered image.

17. The method of claim 10, comprising using the electronic mobile imaging and communication device to combine the plurality of panoramic images to obtain a single composite image.

18. The imaging apparatus of claim 1, wherein the electronic mobile imaging and communication device is a mobile phone.

19. An adaptor for mounting an imaging device to a microscope, the adaptor comprising:
a coupler portion;
a support plane for receiving the imaging device; and
a through-hole extending through the support plane and the coupler portion, wherein the coupler comprises an elongated opening configured to be positioned over a microscope eyepiece.

20. The adaptor of claim 19, further comprising a raised frame extending around a perimeter of the support plane, and wherein the coupler portion is adjustable.

21. The adaptor of claim 19, further comprising a spacer configured to be positioned inside of the coupler, wherein the spacer has a substantially cylindrical shape and a hollow center.
